(19) United States
(12) Patent Application Publication
(10) Pub. No.: US 2019/0338998 A1
(43) Pub. Date: Nov. 7, 2019

(54) ENCLOSURE FOR REFRIGERATING CHAMBERS

(71) Applicant: AMISERRU, S.L., Sant Cugat del Valles (ES)

(72) Inventor: Miguel Angel IGLESIAS BALLESTER, Sant Cugat del Valles (ES)

(21) Appl. No.: 16/387,787

(22) Filed: Apr. 18, 2019

(30) Foreign Application Priority Data
May 4, 2018 (ES) P201830440

(51) Int. Cl. F25D 23/02; F25D 21/12; E05D 15/16; E06B 9/13

(52) U.S. Cl. CPC F25D 23/021; F25D 21/125; F25D 23/028; E05Y 2900/31; E05D 15/165; E06B 9/13; F25D 2323/02; F25D 23/025

(57) ABSTRACT

The invention relates to an enclosure for refrigerating chambers, suitable for closing an access (3) to a refrigerating chamber and comprising: —a sliding refrigerating door (1), and —a quick-opening door (2), both assembled on the same side of the chamber, comprising a frame with vertical posts (4), comprising: —on an outer face, at least one mouth (42) wherein a fan (6) is coupled which introduces air in the corresponding vertical post (4); —on the inside thereof, a deflector plate (61) which directs the air towards electrical resistors (7) for heating the air, situated underneath the deflector plate and, —on an inner face, an outlet (43) for supplying hot air on one of the surfaces, inner or outer, of the flexible sheet (21) exposed to the cold of the chamber and removing frost from said flexible sheet (21).

### CROSS REFERENCE TO RELATED APPLICATIONS

This application claims priority to Spanish Patent Application No. P201830440, filed on May 4, 2018, the entire disclosure of which is hereby incorporated by reference.

### OBJECT OF THE INVENTION

The object of the present invention is an enclosure for refrigerating chambers, suitable for closing an access opening to a refrigerating chamber and comprising: a sliding refrigerating door, and a quick-opening door which has a frame provided with vertical posts, at least one flexible sheet exposed to the cold of the refrigerating chamber movable along guides of the vertical posts; and a motorised drum, provided with a protective cover, for rolling and unrolling said flexible sheet.

This enclosure for refrigerating chambers has constructive particularities intended to prevent frost from forming on the flexible sheet of the rolling door exposed to the cold of the refrigerating chamber; and eventually, additionally, to prevent ice or frost from forming in the rolling area of the flexible sheet situated inside the protective cover.

### FIELD OF APPLICATION OF THE INVENTION

This invention is applicable in the sector of refrigerating chambers.

### STATE OF THE ART

Document ES 2 166 246 B1 of the same applicant describes a closing system for refrigerating chambers comprising a sliding refrigerating door and parallel to it, in the direction towards the inside of the chamber, a quick-opening door intended to minimise the temperature losses while the outer refrigerating door stays open.

In said prior art, both the refrigerating or insulating door and the quick-opening door are situated on the outer portion of the access opening to the refrigerating chamber such that the flexible sheet of the quick-opening door stays exposed to the cold from the inside of the refrigerating chamber but the motorised drum responsible for rolling and unrolling said flexible sheet is arranged on the outer portion of the access opening to the chamber.

An additional drawback of this type of door is the formation of frost on the flexible sheet of the quick-opening door which stays exposed to the cold from the inside of the refrigerating chamber since this frost considerably and irregularly increases the thickness of the flexible sheet, and when it is rolled onto the motorised drum, during the opening operations of the door it forms a roll that is too thick which can butt against the protective cover of the motorised drum.

In the case of the quick-opening door having two parallel flexible sheets, which create an insulating chamber between them, the thickness of the frost is only produced on one of the flexible sheets, specifically the flexible sheet exposed to the cold of the refrigerating chamber; causing the movement of the two flexible sheets to not be performed in a coordinated manner, which can cause operating errors of the quick-opening door.

Although it is true that there is some prior art of quick-opening doors with flexible sheets and which incorporate means for projecting air into the space comprised between both flexible sheets, the proposed solutions are not especially effective in the case of enclosures for refrigerating chambers, like the one described previously, since the projected air does not reach the entire surface of the flexible sheets in a uniform manner, mainly due to the fact that air at a higher temperature moves towards the upper area of the opening and does not prevent frost from forming in the lower portion of the flexible sheet in contact with the low temperatures existing inside the refrigerating chamber.

The applicant does not know of the existence of prior art which satisfactorily solves the explained problem and which has characteristics analogous to those of the present invention.

### DESCRIPTION OF THE INVENTION

The enclosure for refrigerating chambers object of this invention is suitable for closing an access opening to a refrigerating chamber and, comprising a sliding refrigerating door; and a quick-opening door comprising: a frame provided with vertical posts, at least one flexible sheet, exposed to the cold of the chamber, movable along guides of the vertical posts; and a motorised drum, provided with a protective cover, for rolling and unrolling said flexible sheet, as envisaged in the preamble of the main claim; it has characteristics intended to satisfactorily solve the previously explained problem and, specifically, preventing frost from forming on the flexible sheet of the quick-opening door exposed to the cold of the chamber.

To do so and according to the invention, the vertical posts of the frame of the quick-opening door comprise: —on an outer face, at least one mouth wherein a fan is coupled in order to introduce air to the corresponding vertical post; —on the inside thereof, a deflector plate which directs the air supplied by the fan to the lower area of the vertical post, and underneath said deflector plate electrical resistors for heating the supplied air and, —on an inner face, an outlet for supplying hot air on one of the surfaces, inner or outer, of the flexible sheet exposed to the cold of the chamber and the removal of frost from said flexible sheet.

The arrangement on the inside of the very vertical posts of the quick-opening door of the mentioned reflecting plate and, underneath it, the electrical resistors responsible for heating the supplied air which, besides simplifying the assembly thereof, ensure that the hot air is directed towards the lower area of the quick-opening door rising along the inner or outer surface of the flexible sheet of the quick-opening door exposed to the cold, ensuring that frost is not formed on any point of the surface thereof.

In order to ensure this objective, depending on the height of the door, it has been foreseen that each of the vertical posts of the frame of the quick-opening door incorporates several groups of fans, reflectors, resistors and hot air outlets arranged at different heights, ensuring that the hot air reaches the upper area, the intermediate area and the lower area of the flexible sheet.

In one embodiment of the invention, the quick-opening door incorporates, on the inside of the protective cover of the motorised drum, electrical resistors which prevent ice or frost from forming in said area.

It is worth mentioning that the hot air outlets can be arranged on one side or another of the flexible sheet of the quick-opening door exposed to the cold of the refrigerating chamber and that said quick-opening door can have a single flexible sheet, or two flexible sheets arranged parallel to each other and which are rolled or unrolled simultaneously in the motorised drum.

In an alternative embodiment of the invention, the means for preventing frost from forming on the flexible sheet of the quick-opening door oriented towards the inside of the chamber are arranged on the top and not in the vertical posts of the frame.

The characteristics of the invention shall be more readily understandable in light of the exemplary embodiment shown in the attached figures described below

### DESCRIPTION OF THE FIGURES

As a complement to the description provided herein, and for the purpose of helping to make the characteristics of the invention more readily understandable, the present specification is accompanied by a set of drawings which, by way of illustration and not limitation, represent the following:

FIG. 1 shows a schematic profile view of an exemplary embodiment of the enclosure for refrigerating chambers according to the invention wherein the refrigerating door and the quick-opening door, in this case with a double flexible sheet, are assembled on the outer side of the access opening to the chamber; there being a cross section of the quick-opening door and a portion of the chamber along a vertical plane.

FIG. 2 shows an elevation view of the enclosure of FIG. 1 seen from the inside of the refrigerating chamber and in a partial cross section in order to enable the visualisation of the means for supplying hot air to the flexible sheet of the quick-opening door oriented towards the inside of the refrigerating chamber.

FIG. 3 shows a view similar to FIG. 1 of a variant embodiment wherein the quick-opening door has a single flexible sheet and the hot air outlets project the air on the outer surface of the flexible sheet, meaning, on the surface oriented towards the outside of the chamber.

FIG. 4 shows an alternative embodiment of the invention, wherein the fans and the resistors for heating the air are housed in a device situated in the upper portion of the access opening, and not in the vertical posts of the frame, projecting the hot air from the upper portion towards the lower area.

### PREFERRED EMBODIMENT OF THE INVENTION

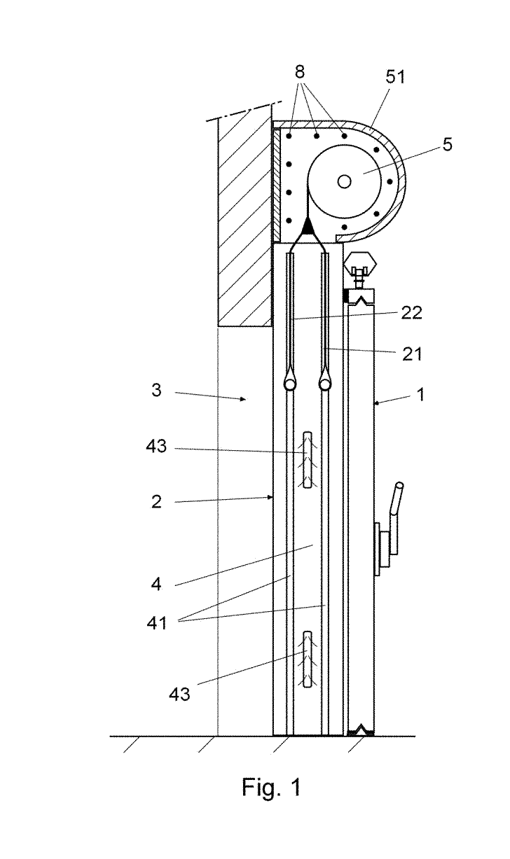

In an exemplary embodiment shown in FIG. 1, the enclosure comprises a sliding refrigerating door (1) assembled against a quick-opening door (2) which is in turn installed on the outer side of an access opening (3) to a refrigerating chamber.

The quick-opening door (2) comprises a frame provided with vertical posts (4) which have vertical guides (41) for the movement of flexible sheets (21, 22) which are rolled or unrolled simultaneously in a motorised drum (5) provided with a protective cover (51).

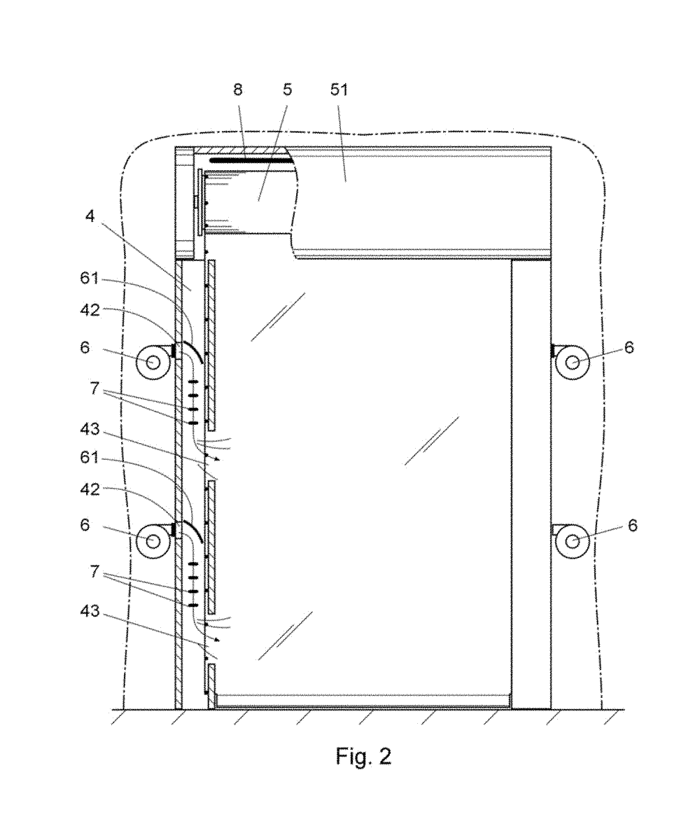

As seen in FIG. 2, the vertical posts (4) have on the outer face thereof mouths (42) wherein fans (6) are assembled which blow air towards the inside of said vertical posts (4).

Inside the vertical posts (4) there are deflector plates (61) which direct the air towards the lower air causing the circulation thereof on electrical resistors (7) which perform the heating thereof.

Said vertical posts (4) have on the inner face, which delimits the access opening (3), outlets (43) arranged at different heights, for supplying hot air, in this case, towards the space comprised between the two flexible sheets (21, 22) of the quick-opening door (2), preventing frost from forming on the flexible sheet (22) exposed to the cold of the chamber.

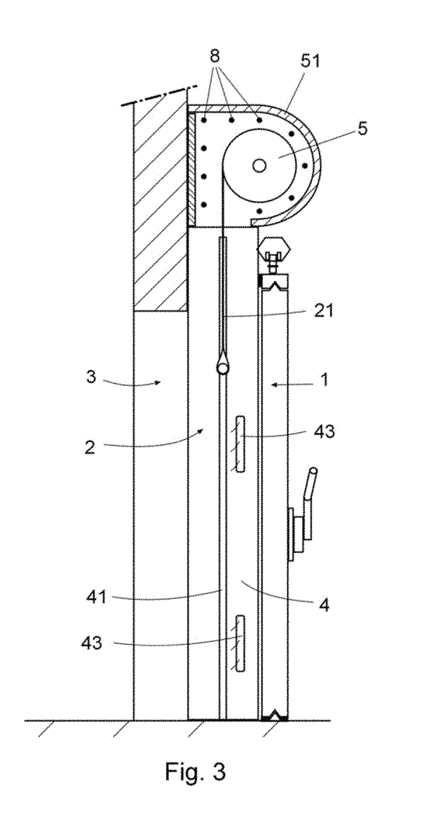

In the variant embodiment shown in FIG. 3, the quick-opening door has a single closing flexible sheet (21), the outlets (43) being conveniently arranged to supply the hot air on the outer surface thereof of the flexible sheet (21) oriented towards the outside of the refrigerating chamber.

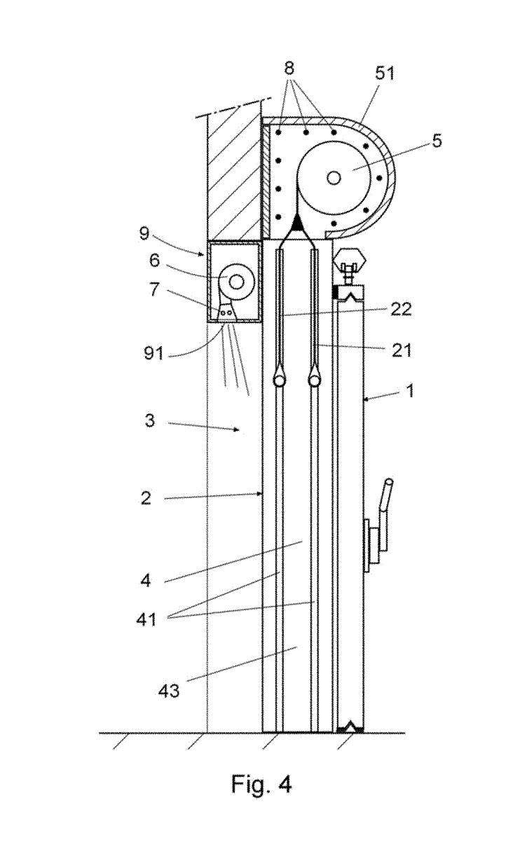

In the variant embodiment shown in FIG. 4, the quick-opening door comprises in the upper portion thereof, on the side oriented towards the inside of the refrigerating chamber, a heating device (9) which has on the inside thereof: fans (6) which blow air at a variable speed towards a lower area and electrical resistors (7) which heat the air projected by the fans (6); said heating device (9) having in a lower area slits (91) which project the hot air towards the flexible sheet (22) of the quick-opening door exposed to the cold of the chamber, preventing frost from forming thereon.

In the embodiments shown, the motorised drum (5) is assembled on the side of the access opening corresponding to the inside of the refrigerating chamber, facilitating the assembly of the enclosure. In these embodiments, the enclosure comprises on the inside of the space delimited by the protective cover (51) electrical resistors (8) which prevent ice or frost from forming in said area.

Having sufficiently described the nature of the invention, in addition to a preferred exemplary embodiment, it is hereby stated for the relevant purposes that the materials, shape, size and layout of the described elements may be modified, provided that it does not imply altering the essential characteristics of the invention claimed below.

1. An enclosure for refrigerating chambers, suitable for closing an access opening (3) to a refrigerating chamber and comprising: a sliding refrigerating door (1) and a quick-opening door (2), both assembled on one same side of the access opening (3) to the refrigerating chamber, and comprising a frame provided with vertical posts (4), at least one flexible sheet (21, 22), exposed to the cold of the chamber, movable along guides (41) of the vertical posts (4), and a motorised drum (5), provided with a protective cover (51), for rolling and unrolling said flexible sheet (21, 22); wherein the vertical posts (4) of the frame of the quick-opening door (2) comprise:
on an outer face, at least one mouth (42) wherein a fan (6) is coupled which introduces air in the corresponding vertical post (4);
on the inside thereof, a deflector plate (61) which directs the air supplied by the fan (6) to the lower area of the vertical post (4), and underneath said deflector plate (61) electrical resistors (7) for heating the supplied air; and
on an inner face, an outlet (43) for supplying hot air on one of the surfaces, inner or outer, of the flexible sheet (21) exposed to the cold of the chamber and removing frost from said flexible sheet (21).

2. The enclosure, according to claim 1, wherein each of the vertical posts (4) of the frame of the quick-opening door (2) comprises several groups of fans (6), deflectors (61), resistors (7) and hot air outlets (43) arranged at different heights.

3. The enclosure, according to claim 1, wherein the quick-opening door (2) and the motorised drum (5) are attached to the access opening (3) by the side opening of the refrigerating chamber; and incorporates on the inside of the protective casing (51) of the motorised drum (5) electrical resistors (8) which prevent frost from forming in said area.

4. The enclosure, according to claim 1, wherein the quick-opening door (2) comprises two flexible sheets (21, 22), parallel, with simultaneous rolling; the hot air outlets (43) of the vertical posts (4) being defined comprised between the guides (41) of said flexible sheets (21, 22).

5. The enclosure, according to claim 1, wherein the quick-opening door (2) has a single closing flexible sheet (21), the outlets (43) being conveniently arranged to supply the hot air on the outer surface of the flexible sheet (21) oriented towards the refrigerating chamber.

6. An enclosure for refrigerating chambers, suitable for closing an access opening (3) to a refrigerating chamber and comprising: a sliding refrigerating door (1) and a quick-opening door (2), both assembled on one same side of the access opening (3) to the refrigerating chamber, and comprising a frame provided with vertical posts (4), at least one flexible sheet (21, 22), exposed to the cold of the chamber, movable along guides (41) of the vertical posts (4), and a motorised drum (5), provided with a protective cover (51), for rolling and unrolling said flexible sheet (21, 22); wherein the quick-opening door (2) comprises in the upper portion thereof, on the side oriented towards the inside of the refrigerating chamber, a heating device (9) which has on the inside thereof: fans (6) which blow air at a variable speed towards a lower area and electrical resistors (7) which heat the air projected by the fans (6); said heating device (9) having in a lower area slits (91) which project the hot air towards the flexible sheet (22) of the quick-opening door exposed to the cold of the chamber, preventing frost from forming thereon.

7. The enclosure, according to claim 2, wherein the quick-opening door (2) and the motorised drum (5) are attached to the access opening (3) by the side opening of the refrigerating chamber; and incorporates on the inside of the protective casing (51) of the motorised drum (5) electrical resistors (8) which prevent frost from forming in said area.

8. The enclosure, according to claim 7, wherein the quick-opening door (2) comprises two flexible sheets (21, 22), parallel, with simultaneous rolling; the hot air outlets (43) of the vertical posts (4) being defined comprised between the guides (41) of said flexible sheets (21, 22).

9. The enclosure, according to claim 7, wherein the quick-opening door (2) has a single closing flexible sheet (21), the outlets (43) being conveniently arranged to supply the hot air on the outer surface of the flexible sheet (21) oriented towards the refrigerating chamber.

10. The enclosure, according to claim 2, wherein the quick-opening door (2) comprises two flexible sheets (21, 22), parallel, with simultaneous rolling; the hot air outlets (43) of the vertical posts (4) being defined comprised between the guides (41) of said flexible sheets (21, 22).

11. The enclosure, according to claim 2, wherein the quick-opening door (2) has a single closing flexible sheet (21), the outlets (43) being conveniently arranged to supply the hot air on the outer surface of the flexible sheet (21) oriented towards the refrigerating chamber.

12. The enclosure, according to claim 3, wherein the quick-opening door (2) comprises two flexible sheets (21, 22), parallel, with simultaneous rolling; the hot air outlets (43) of the vertical posts (4) being defined comprised between the guides (41) of said flexible sheets (21, 22).

13. The enclosure, according to claim 3, wherein the quick-opening door (2) has a single closing flexible sheet (21), the outlets (43) being conveniently arranged to supply the hot air on the outer surface of the flexible sheet (21) oriented towards the refrigerating chamber.
